(19) United States
(12) Patent Application Publication
(10) Pub. No.: US 2025/0199785 A1
(43) Pub. Date: Jun. 19, 2025

(54) COMPILATION METHODS, COMPILERS, AND WASM VIRTUAL MACHINES

(71) Applicant: Ant Blockchain Technology (Shanghai) Co., Ltd., Shanghai (CN)

(72) Inventors: Wei Zhou, Hangzhou (CN); Rong Cao, Hangzhou (CN)

(73) Assignee: Ant Blockchain Technology (Shanghai) Co., Ltd., Shanghai (CN)

(21) Appl. No.: 19/065,691

(22) Filed: Feb. 27, 2025

Related U.S. Application Data
(63) Continuation of application No. PCT/CN2022/135270, filed on Nov. 30, 2022.

(30) Foreign Application Priority Data
Aug. 31, 2022 (CN) 202211066051.5

(51) Int. Cl. G06F 8/41; G06F 9/455

(52) U.S. Cl. CPC G06F 8/4434; G06F 9/45504

(57) ABSTRACT

Compiling code comprising reflection functionality is described. A computer-implemented method includes scanning, by a compiler, reflection functionality code starting from a program entry of the code, and obtaining, based on an annotation and as a used class, a class used in the reflection functionality code and a function used by the class. Code of the used class and the function used by the class are added, by the compiler to a list of code to be compiled, in a class upon which the code comprising reflection functionality depends, where the code of the used class and the function used by the class are obtained based on the annotation. The list of code to be compiled is compiled by the compiler to obtain WebAssembly bytecode. The computer-implemented method can be applied to a blockchain.

### CROSS-REFERENCE TO RELATED APPLICATIONS

This application is a continuation of PCT Application No. PCT/CN2022/135270, filed on Nov. 30, 2022, which claims priority to Chinese Patent Application No. 202211066051.5, filed on Aug. 31, 2022, and each application is hereby incorporated by reference in its entirety.

### TECHNICAL FIELD

Embodiments of this specification pertain to the field of compiler technologies, and in particular, relate to compilation methods, compilers, and Wasm virtual machines.

### BACKGROUND

WebAssembly (Wasm for short) is an open standard developed by the W3C Community Group. It is a secure and portable low-level code format designed for efficient execution and compact representation. WebAssembly can run with near-native performance and provide a compilation target for a language such as C, C++, Java, or Go. The Wasm virtual machine was originally designed to solve increasingly severe performance problems of Web programs. Due to its superior features, the Wasm virtual machine is used by more non-Web projects, for example, to replace a smart contract execution engine EVM in a blockchain.

### SUMMARY

An objective of this application is to provide compilation methods, compilers, and Wasm virtual machines. A method for compiling code including reflection functionality includes: scanning, by a compiler, reflection functionality code starting from a program entry of the code, and obtaining, based on an annotation, a class used in the reflection functionality code and a function used by the class; adding, by the compiler to a list of code to be compiled, code of the used class and the function used by the class, which are obtained based on the annotation, in a class upon which the code including reflection functionality depends; and compiling, by the compiler, the list of code to be compiled to obtain Wasm bytecode.

A compiler includes: a scanning unit, configured to scan reflection functionality code starting from a program entry of code, and obtain, based on an annotation, a class used in the reflection functionality code and a function used by the class; an addition unit, configured to add, to a list of code to be compiled, code of the used class and the function used by the class, which are obtained based on the annotation, in a class upon which the code including reflection functionality depends; and a compilation unit, configured to compile the list of code to be compiled to obtain Wasm bytecode.

A computer device includes a processor and a memory. The memory stores a program. When the processor executes the program, the following operations are performed: scanning reflection functionality code starting from a program entry of code, and obtaining, based on an annotation, a class used in the reflection functionality code and a function used by the class; adding, to a list of code to be compiled, code of the used class and the function used by the class, which are obtained based on the annotation, in a class upon which the code including reflection functionality depends; and compiling the list of code to be compiled to obtain Wasm bytecode.

A storage medium is configured to store a program. When the program is executed, the following operations are performed: scanning reflection functionality code starting from a program entry of code, and obtaining, based on an annotation, a class used in the reflection functionality code and a function used by the class; adding, to a list of code to be compiled, code of the used class and the function used by the class, which are obtained based on the annotation, in a class upon which the code including reflection functionality depends; and compiling the list of code to be compiled to obtain Wasm bytecode.

According to the above-mentioned embodiments, for directly or indirectly depended classes, only functions specified by the annotation will be compiled together. In these directly or indirectly depended classes, many functions that will not be subsequently called will not be compiled by the compiler. Therefore, in the compilation process, the compiler can have a capability of “compilation on demand”. This can not only reduce complexity and workload of the compiler, but also greatly reduce a size of a compilation result. Moreover, due to the small size of the compilation result, code loaded into linear memory of the Wasm virtual machine will also be greatly reduced, and overall performance of the Wasm virtual machine can be improved.

### BRIEF DESCRIPTION OF DRAWINGS

To describe the technical solutions in the embodiments of this specification more clearly, the following briefly describes the accompanying drawings required for describing the embodiments. Clearly, the accompanying drawings in the following description show merely some embodiments described in this specification, and a person of ordinary skill in the art may still derive other drawings from these accompanying drawings without creative efforts.

FIG. 1 is a schematic diagram illustrating a compilation and execution process of a Java program, according to one or more embodiments;

FIG. 2 is a flowchart illustrating a process in which a compiler can compile Java source code into a Wasm file;

FIG. 3 is a schematic diagram illustrating a structure of bytecode and modules of a virtual machine module, according to one or more embodiments;

FIG. 4 is a schematic diagram illustrating a relationship between a table in linear memory and a table in normal memory, according to one or more embodiments;

FIG. 5 is a flowchart illustrating a process in which Java is used for development, Wasm bytecode is obtained after compilation by a compiler, and the Wasm bytecode runs on various platforms integrated with a Wasm virtual machine, according to one or more embodiments; and

FIG. 6 is a flowchart illustrating a compilation method, according to one or more embodiments.

### DESCRIPTION OF EMBODIMENTS

To enable a person skilled in the art to understand the technical solutions in this specification better, the following clearly and comprehensively describes the technical solutions in the embodiments of this specification with reference to the accompanying drawings in the embodiments of this specification. Clearly, the described embodiments are merely some but not all of the embodiments of this specification. Based on the embodiments of this specification, all other embodiments obtained by a person of ordinary skill in the art without creative efforts shall fall within the protection scope of this specification.

High-level computer languages are convenient for people to write, read, communicate, and maintain, while machine languages can be directly interpreted and executed by computers. A compiler can take a source program in an assembly or high-level computer language as an input and translate the source program into an equivalent program with target language machine code. Source code is generally written in a high-level language, such as C or C++. The target is object code in a machine language, sometimes also referred to as machine code. Then the machine code (or referred to as “microprocessor instructions”) can be executed by a CPU. This method is generally referred to as “execution after compilation”.

Execution after compilation generally does not have cross-platform scalability. There are CPUs from different vendors, brands, and generations, but instruction sets supported by these different CPUs are often different, such as an x86 instruction set and an ARM instruction set, and instruction sets supported by CPUs from the same vendor and same brand but different generations (such as different generations of Intel CPUs) are not exactly the same. Therefore, the same program code written in the same high-level language may be converted into different machine code by compilers on different CPUs. Specifically, in a process of converting program code written in a high-level language into machine code, the compiler optimizes the program code with reference to characteristics of a specific CPU instruction set (such as a vector instruction set) to increase a program execution speed, and such optimization is often related to specific CPU hardware. Therefore, the same machine code can run on an x86 platform, but may not run on another ARM. Even for the same x86 platform, because the instruction set is constantly enriched and extended over time, machine code running on different generations of x86 platforms also varies. Moreover, because execution of the machine code requires an operating system kernel to schedule a CPU, even if the hardware is the same, the machine code supported by different operating systems may be different.

Different from execution after compilation, there is also a program running mode known as “execution after interpretation”. For example, for high-level languages such as Java and C#, a function of the compiler in this case is to compile source code into bytecode in a universal intermediate language.

For example, Java source code in a Java language is compiled into standard bytecode by a Java compiler. Here, the compiler does not target an instruction set of any actual hardware processor, but defines a set of abstract standard instructions. The compiled standard bytecode generally cannot run directly on a hardware CPU. Therefore, a virtual machine, that is, a JVM, is introduced. The JVM runs on a specific hardware processor to interpret and execute the compiled standard bytecode.

The Java virtual machine, JVM for short, is a virtual computer usually implemented by emulating or simulating various computer functions on an actual computer. The JVM masks information related to specific hardware platforms, operating systems, etc., allowing a Java program to run on various platforms without any modification as long as standard bytecode capable of running on the Java virtual machine is generated.

A very important feature of the Java language is its platform independence. Use of the Java virtual machine is the key to achieving this feature. Generally, if a high-level language is to run on different platforms, it at least needs to be compiled into different target code. After the Java virtual machine is introduced, the Java language does not need to be recompiled when running on different platforms. The Java language uses the Java virtual machine to mask information related to specific platforms. Therefore, as long as the Java language compiler generates target code (bytecode) that runs on the Java virtual machine, the target code can run on various platforms without any modification. When executing the bytecode, the Java virtual machine interprets the bytecode into machine instructions for execution on a specific platform. This is why Java can “run anywhere after being compiled once”. Therefore, as long as it is ensured that the JVM can correctly execute a .class file, the file can run on different operating system platforms such as Linux, Windows, and MacOS.

The JVM runs on a specific hardware processor and is responsible for interpreting and executing bytecode for the specific processor on which the JVM runs. The JVM also masks these underlying differences and presents standard development specifications to developers. Actually, when executing the bytecode, the JVM eventually interprets the bytecode into machine instructions for execution on the specific platform. Specifically, after receiving the input bytecode, the JVM interprets instructions one by one and translates the instructions into machine code suitable for running on the current machine. These processes are performed, for example, by an interpreter known as the “Interpreter”, which is in charge of interpretation and execution. As such, a developer who writes a Java program does not need to consider on which hardware platform the written program code will run. Development of the JVM itself is completed by a professional developer of a Java organization to adapt the JVM to different processor architectures. So far, there are only a limited quantity of mainstream processor architectures, such as X86, ARM, RISC-V, and MIPS. After the professional developer ports the JVM to platforms supporting these specific hardware types, the Java program can theoretically run on all machines. Porting of the JVM is usually provided by professional personnel of a Java development organization, which greatly reduces burden on Java application developers.

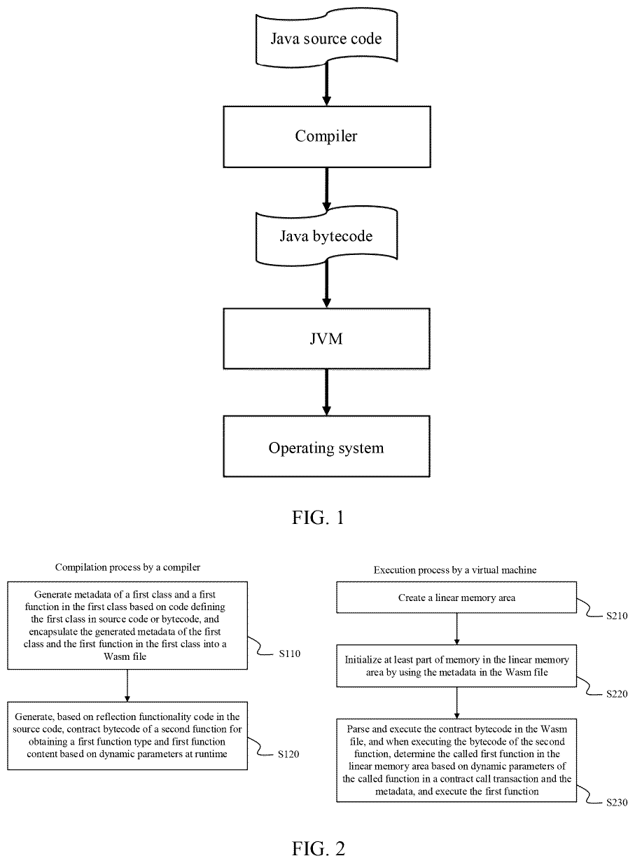

The compilation and execution process of the above-mentioned Java program is shown in FIG. 1. Java source code developed by a developer generally has an extension .java. After a source file is compiled by the compiler, a file with an extension .class is generated, and the .class file is bytecode. Bytecode instructions are also known as opcode. The JVM parses the opcode and operands to complete program execution. When a Java command is used to run the .class file, it is actually equivalent to starting a JVM process in an operating system and requesting part of memory from the operating system. This part of memory is generally managed directly by the virtual machine, and can specifically include a method area, a heap area, a stack area, etc. The bytecode is translated and executed by the JVM, which involves two specific execution methods. One common method is execution after interpretation, which means that the opcode and operands are translated into machine code and then handed over to the operating system for execution. The other execution method is just in time (JIT), which is just-in-time compilation. In this method, the bytecode is compiled into machine code under certain conditions before execution.

Execution after interpretation brings cross-platform portability. However, because the execution of the bytecode goes through an intermediate translation process on the JVM, execution efficiency is not as high as efficiency of the above-mentioned execution after compilation. This efficiency difference can sometimes even be up to dozens of times.

After years of development and accumulation, Java has become a mature programming language. In one aspect, the size of the .class file compiled by the compiler is reduced. To reduce the size of the .class file and make Java bytecode easier to distribute, the JVM integrates a large quantity of depended libraries and provides standardized APIs. For example, the Java source code developed by the developer includes two files, Person .java and Main .java, and a header of the Main .java file declares import of Person. Actually, Main and the Person file upon which it depends involve more depended classes at runtime, such as a default parent class and an ancestor class (a specific example is an indirectly depended string class String.class). If the JVM does not integrate a large quantity of depended libraries, Person, Main, and depended classes need to be compiled together in the compilation process, but there are more compiled.class files obtained in this way, and a total size is also larger. After the JVM integrates a large quantity of standard libraries, the JVM needs to load fewer .class files externally by using a class loader during the execution of the Java program, and the size is also smaller, but the depended classes still need to be loaded internally, for example, through a local file or a network. Another aspect is a dynamic loading feature of the JVM. As mentioned above, when the JVM executes the .class files of the Java bytecode, such as Person .class and Main .class in the above example, the JVM needs to load many depended class files in addition to loading the two bytecode files. The dynamic loading feature means that the JVM does not load all classes into memory once, but loads classes on demand. Specifically, only when the JVM uses a class that has not been loaded, will the JVM load the class. The dynamic class loading feature of the JVM allows the Java program to control loading of different implementation classes based on conditions at runtime, thereby reducing memory usage. The memory usage directly affects execution efficiency of the JVM.

Java and other languages use virtual machines that run instruction sets on general-purpose hardware like x86, and then execute their own “assembly language” (for example, Java bytecode). Actually, a web platform also uses a virtual machine environment similar to Java and Python in a browser. The browser provides a virtual machine environment to execute JavaScript or some other scripting languages, thereby implementing interactive behaviors on HTML pages and some specific behaviors on web pages. For example, a specific behavior on a web page is to embed a dynamic text. As service needs are increasingly complex, development logic of a front end also becomes more complex, accompanied by an increasing amount of code, and a longer project development cycle. In addition to the complex logic and the large amount of code, another reason is an inherent flaw of JavaScript itself-lack of static variable types, which reduces efficiency. Specifically, a JavaScript engine caches and optimizes a function that is executed frequently in JavaScript code. For example, the JavaScript engine compiles the code into machine code, which is then packaged and sent to a JIT compiler, and compiled by the JIT compiler into machine code; and when this function is executed again next time, the compiled machine code is executed directly. However, JavaScript uses a dynamic variable, and this variable may be an array last time and may become an object next time. Therefore, the optimization performed by the JIT compiler last time becomes ineffective, and optimization needs to be performed again next time.

In 2015, WebAssembly (also abbreviated as Wasm) emerged. WebAssembly is an open standard developed by the W3C Community Group. It is a secure and portable low-level code format specially designed for efficient execution and compact representation, capable of running with near-native performance. WebAssembly is code compiled by a compiler, with a small size and a high startup speed. It is completely independent of JavaScript in terms of syntax, while providing a sandboxed execution environment. WebAssembly uses static typing to improve execution efficiency. In addition, WebAssembly brings many programming languages to the web. Moreover, WebAssembly further simplifies some execution processes, also resulting in a significant improvement in execution efficiency.

WebAssembly is a completely new format that is portable, small in size, fast to load, and compatible with the web. It can be used as a compilation target for C/C++/Rust/Java, etc. WebAssembly can be considered as a universal instruction set for x86 hardware on the web platform. As an intermediate language, WebAssembly interfaces with higher-level languages such as Java, Python, Rust, and C++, so that all these languages can be compiled into a unified format for running on the web platform.

For example, a source file developed in the C++ language generally has an extension .cpp. The cpp file can be compiled by the compiler to generate bytecode in a Wasm format. Similarly, a source file developed in the Java language generally has an extension .java. The java file can be compiled by the compiler to generate bytecode in the Wasm format. The bytecode in the Wasm format can be encapsulated into a wasc file. The wasc file is a file that combines the bytecode and application binary interface (ABI). A WebAssembly virtual machine (also known as a Wasm virtual machine or a Wasm runtime environment, which is a virtual machine runtime environment for executing Wasm bytecode), implemented based on open standards of the W3C community, implements runtime loading, interpretation, and execution of the Wasm bytecode.

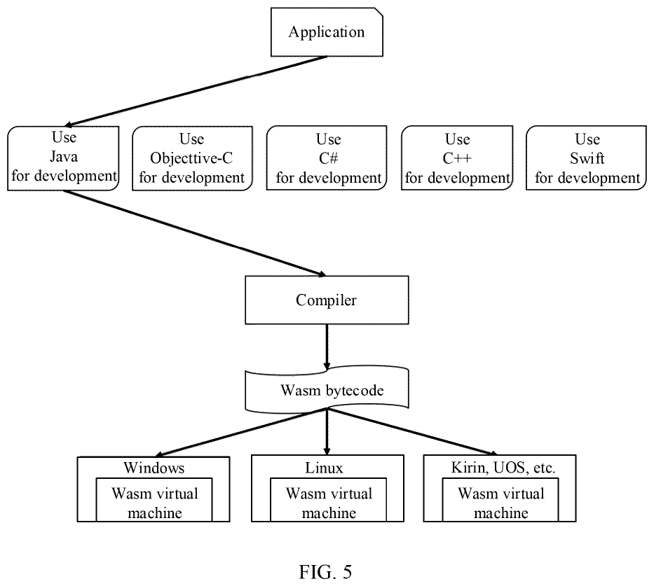

For example, to achieve cross-platform development of an application, Java is used for development on a Linux platform, Objective-C is used for development on an iOS, C# is used for development on a Windows platform . . . With Wasm, it is only necessary to choose any language, compile it into Wasm, and distribute it to various platforms. For example, as shown in FIG. 5, Java is used for development, Wasm bytecode may be obtained after compilation by a compiler, and the Wasm bytecode can run on various platforms integrated with a Wasm virtual machine.

The Wasm virtual machine was originally designed to solve increasingly severe performance problems of Web programs. Due to its superior features, the Wasm virtual machine is used by more non-Web projects, for example, to replace a smart contract execution engine EVM in a blockchain.

Programs developed in different high-level languages may behave differently due to different features of these high-level languages. For example, because the Java language has a reflection mechanism, a program developed in the Java language can implement reflection functionality when running on a corresponding JVM virtual machine. The reflection mechanism, also known as reflection programming, refers to a capability of a computer program to access, detect, and change its own status or behavior when running. The reflection programming functionality in the Java programming language is common functionality, typically supporting dynamic execution, while the Wasm bytecode standard does not directly support reflection functionality. High-level languages with reflection programming functionality further include C#, Python, the Go language, etc. in addition to Java. Some parts of this application are mainly described by using Java as an example. Certainly, it is also applicable to C#, Python, the Go language, etc.

For example, in the blockchain, a smart contract developed by a developer can provide different functions to implement different functionality. Subsequently, a contract caller can dynamically call one or more functions in the contract to implement specific functionality. For a high-level programming language that does not support reflection functionality, the developer generally needs to explicitly write conversion from method names to method calls involved in calling different functions in code when developing the contract. The code is complex and lengthy. For a high-level programming language that supports reflection functionality, the developer can flexibly and easily implement conversion from method names to method calls involved in calling different functions in code with reflection functionality when developing the contract.

For example, in high-level languages such as C++ that do not support reflection programming, if dynamic execution is to be implemented, generally, dynamic execution can be implemented based on demand by using a branch structure. For example, the following C++ program simulates dynamic execution of different methods:

| | |
|---|---|
| 1 | int invokeMethod(string func, int arg1, int arg2) { |
| 2 | if(func == “sum”) { |
| 3 | return arg1 + arg2; |
| 4 | } |
| 5 | if (func == “multiply”) { |
| 6 | return arg1 * arg2; |
| 7 | } |
| 8 | ... |
| 9 | ... |
| 10 | printf(“not found”); |
| 11 | return 0; |
| 12 | } |

Code snippet 1

Code snippet 1 in a C++ contract provides functions such as sum and multiply for a contract caller to initiate calls and pass parameters. In a certain contract call, the contract cannot know in advance which specific function in the contract will be called by the initiated contract call transaction. Therefore, an if branch is usually used to match the initiated contract call. After successful matching, a corresponding parameter is passed to the function to execute the function and return a result. This method simulates dynamic execution. In a case that there are many functions in the contract, this part of code is complex and lengthy.

For example, code with similar functionality can be implemented in Java by using the reflection mechanism.

| | |
|---|---|
| 1 | class Person { |
| 2 | int getSum(int a, int b) { return a + b; } |
| 3 | int getMultiply(int a, int b) { return a + b; } |
| 4 | String hello(String name) { return ″hello ″ + name; } |
| 5 | } |

Code snippet 2: Person.java

| | |
|---|---|
| 1 | import Person |
| 2 | class Main |
| 3 | public static void main(String[ ] args) { |
| 4 | String methodName = args[0]; |
| 5 | Method method = Person.class.getMethod(methodName, int.class, |
| | int.class); |
| 6 | System.out.println(method.invoke(123,234)); |
| 7 | } |
| 8 | } |
| 9 | |

Code snippet 3: Main.java

In code snippet 2, Person.java defines three functions: getSum, getMultiply, and hello. Input parameters of the first two functions getSum and getMultiply are the same, both being two integer variables a and b. An input parameter of the last function hello is different from those of the first two functions, and is a string variable name.

Person is first imported in Main.java in code snippet 3, and a class Main is defined. The class Main defines a function Main. In the function Main, a method name and two parameters of an integer type are obtained by using the method in the fifth and sixth lines. A function corresponding to the method name is called in the seventh line, and parameters 123 and 234 are input. The fifth and sixth lines include a reflection functionality function, that is, person.class.getMethod (methodName, int.class, int.class) is used to obtain a function with the same function name and the same input and output parameters (or return type) in a class to which an object Person belongs (including other subclasses inherited from an Object class) (the function name and input and output parameters are also referred to as a function signature). In the seventh line of code, the fetched function is used to complete calculation and return a calculation result. As such, especially when there are a plurality of functions, it is not necessary to match each function name by using a multi-conditional branch structure to simulate dynamic execution as in the above C++ code.

As mentioned above, the java files in code snippets 2 and 3 above can be compiled by the compiler to generate bytecode in the Wasm format. However, the Wasm virtual machine is different from the JVM. The Wasm virtual machine does not integrate a large quantity of libraries upon which the Java/Wasm files need to depend to run. Therefore, in the process of compiling the java files into Wasm bytecode, the compiler needs to compile the depended classes together, for example, Person in code snippet 2, which is imported in the first line in code snippet 3 above, that is, in the process of compilation to obtain the Wasm bytecode of the Main class, all functions of the depended Person class need to be compiled together.

Clearly, in the fifth and sixth lines in code snippet 3 above, from a perspective of a function input parameter quantity being 2 and an input parameter type being int, only the getSum or getMultiply function in code snippet 1 can be called, and the hello function will not be called. In this case, for the compilation process, if the Person class including the hello function is packaged together, useless functions will take up a large file size. The code snippets above are only examples. In an actual situation, one class may include several functions similar to the hello function, where an input parameter quantity, an input parameter type, an output parameter type, etc. are inconsistent with those in dynamic calls. As such, a large quantity of functions that will not be called subsequently in the class are also compiled by the compiler. In this case, an obtained compilation result will take up a large size. In addition, the above shows only two classes Person and Main. Actually, there are generally many indirectly called classes. For example, the Person class depends on a String class (because the parameter and return type of the hello method in the Person class are of the String class). As a standard class, the String class includes many methods, but most of the time only a small quantity of the methods are used in a program. As such, a large quantity of indirectly depended classes will also be compiled together, but a large quantity of functions that will not be called subsequently in these indirectly depended classes will also be compiled by the compiler. In this case, an obtained compilation result will take up a large size.

Although static analysis can be used to determine depended classes in a general compilation process, this method is limited to situations where reflection functionality code is not used. Because when reflection functionality code is not used, a function to be called is clear, and the compiler can determine exactly which function is to be called when analyzing code content. However, static analysis is not effective in a case that involves reflection functionality code, because the static analysis means cannot determine which function is actually called when the reflection functionality code is executed.

Furthermore, the Wasm virtual machine does not have a dynamic loading capability, but needs to load all depended classes into linear memory once. The Wasm virtual machine manages the linear memory and non-linear memory. The linear memory managed by the Wasm virtual machine has a logical address, not a logical address in system memory. The Wasm virtual machine achieves at least part of a sandbox objective by using the linear memory. Memory addresses in the Wasm file are all within a range of 0 to a linear memory capacity, and will not exceed this linear memory area. Therefore, it is ensured that when the virtual machine executes Wasm bytecode, the virtual machine will not read memory outside the linear memory managed by Wasm, that is, no external information can be read unless it is called by using a host API. As such, reading and writing of all Wasm instructions are access to the addresses in the linear memory, and cannot go out of bounds, thereby achieving the sandbox objective.

Usage of the linear memory has great impact on performance of the Wasm virtual machine. Therefore, in the above-mentioned compilation process, a large quantity of functions that will not be actually called in classes are compiled together to generate compiled bytecode files. When the Wasm virtual machine interprets and executes such bytecode files, metadata of these classes and functions will first be loaded into the linear memory managed by the Wasm virtual machine, thus occupying a large amount of linear memory space, which will affect the performance of the Wasm virtual machine.

Source code that has been written in Java by a developer may already include a reflection mechanism. To enable a Wasm virtual machine to implement reflection functionality when executing a compiled Wasm file, a compiler can perform the following process shown in FIG. 2 when compiling Java source code into a Wasm file.

S110: Generate metadata of a first class and a first function in the first class based on code defining the first class in the source code, and encapsulate the generated metadata of the first class and the first function in the first class into the Wasm file.

For example, in Java source code, classes (usually also referred to as classes) such as Class Person { . . . } in the above-mentioned Java code can be defined. { . . . } can include member variables and member functions. A plurality of classes can be defined in one Java file, and a plurality of member functions can be defined in each class. Each member function may generally include a return type, a function name, an input parameter, etc. These classes can be collectively referred to as the first class, and these member functions can be collectively referred to as the first function. The “first” here can be understood as “first type” or “first class”. On a basis of defining a class, an object can be generated based on the class. Using classes and objects is a main means of object-oriented programming. An object is an abstraction of an objective thing; and a class is an abstraction of the object. A relationship between the object and the class is as follows: The object is an instance of the class, and the class is a template of the object.

The metadata of the first class and the first function can be encapsulated into the Wasm file. The metadata of the first class and the first function can include at least a structure of a first class object and a structure of the first function. Because everything in Java is an object, and the class is also a special object, a special object such as a class also has its own field and a class to which the object belongs. The class to which it belongs can be found later based on this first class object. In addition, a structure of the first class and/or a field structure of the first class may also be included. Whether the structure of the first class and the field structure of the first class are included depends on a compilation scheme of the compiler, and may also depend on whether a field of the first class is used in the first function. For example, one or more fields of the first class need to be used in an implementation of the first function. In a specific example, the metadata of the first class and the first function may include the structure of the first class object, the structure of the first class, the field structure of the first class, the structure of the first function, etc. The specific example is as follows:
Structure of the First Class Object:
   4 bytes, linear memory address of the object class;
   linear memory address of each field array of the object;
Structure of the first class:
   4 bytes, linear memory address of a name string of the class;
   4 bytes, linear memory address of a field array of the class;
   4 bytes, linear memory address of a method function array of the class;
Field structure of the first class:
   4 bytes, quantity of fields of the class;
   4 bytes, linear memory address of a name string of a field;
   4 bytes, linear memory address of a return type of the field;
Function structure of the first class:
   4 bytes, quantity of method functions of the class;
   4 bytes, index of a function in a function table;
   4 bytes, linear memory address of a name string of the function;
   4 bytes, linear memory address of a return type of the function;
   4 bytes, quantity of parameters of the function;
   linear memory address of a parameter type array;
In the above-mentioned metadata, the preceding “-” indicates the first level, and “-” indicates the second level, and the second level is subordinate to the first level closest to the second level.

The metadata of the first class and the first function in the first class can be encapsulated into the Wasm file.

In particular, the metadata, after being loaded by the Wasm virtual machine subsequently, can be loaded into linear memory managed by the Wasm virtual machine. The linear memory managed by the Wasm virtual machine has a logical address, not a logical address in system memory. Here, in the process of encapsulating the metadata into the Wasm file, a logical address in the linear memory in which the metadata are located can be determined. In addition, the virtual machine can also manage non-linear memory, which is also referred to as normal memory later.

The Wasm virtual machine achieves at least part of a sandbox objective and a deterministic objective by using the linear memory. Firstly, memory addresses in the Wasm file are all within a range of 0 to a linear memory capacity, and will not exceed this linear memory area. Therefore, it is ensured that when the virtual machine executes Wasm bytecode, the virtual machine will not read memory outside the linear memory managed by Wasm, that is, no external information can be read unless it is called by using a host API. As such, reading and writing of all Wasm instructions are access to the addresses in the linear memory, and cannot go out of bounds, thereby achieving the sandbox objective. Secondly, various metadata of the class in the Wasm file in the context of this application have been determined during compilation. In particular, logical addresses of the class and its member variables and member functions in the linear memory in the context of this application are also determined. For a blockchain, a process of loading the same contract Wasm file by using Wasm virtual machines on different blockchain nodes and executing contract bytecode in the Wasm file can ensure consistency of various metadata in the class. Specifically, the logical addresses of the class and its member variables and member functions in the linear memory are also consistent (even various information generated based on the logical addresses is also consistent and will not be different due to randomicity of the normal memory), that is, a slight difference will not cause inconsistency between execution results of the same contract bytecode in Wasm virtual machines on different nodes, thereby achieving the deterministic objective.

On the contrary, if C++ code is executed directly without using Wasm virtual machines, randomicity of memory will cause inconsistency, not only inconsistency between execution results on different nodes, but also inconsistency between execution results of the same program executed multiple times on the same node. For example, every time an operation of creating an object by using a new statement based on a class definition is performed, a memory address of the generated object is likely to be different, because this memory address is generally randomly assigned by an operating system based on a memory status. If the program logic includes computing some subsequent content based on this address, the execution results will be inconsistent. For another example, in some implementations of a hash table, hash computation performed based on an address of an object will also cause inconsistency of a storage sequence in the hash table. If there are subsequent operations to traverse the hash table, the sequence will also be inconsistent.

With reference to the above-mentioned Java source code, the metadata of the first class and the first function can be as follows:

TABLE 1
Class structure

| Structure of the class in Wasm | Description of examples (addresses are represented in |
|---|---|
| linear memory | hexadecimal notation) |
| Object structure: | Start address: 0x01020300 |
| 4 bytes, linear memory address | 0x01020304//4 bytes, for example, an address of the |
| of the object class; | class here |
| Class structure: | Start address: 0x01020304 |
| 4 bytes, linear memory address | 0x000a0b00//4 bytes, where for example, an address of |
| of a name string of the class; | a “Person” string in linear memory is an address of a class |
| 4 bytes, linear memory address | name |
| of a field array of the class; | 0x0a0203ab//4 bytes, linear memory address, which is a |
| 4 bytes, linear memory address | start address for storing the field array of the class |
| of a method function array of the | 0x0a020336//4 bytes, linear memory address, which is a |
| class; | start address for storing the method function array of the |
| | class |
| Field array structure of the class: | Start address: 0x010203ab |
| 4 bytes, quantity of fields of the | 0x00000002//4 bytes, quantity of fields of the class, |
| class; | assumed to be 2 here, for example, the two fields name |
| 4 bytes, linear memory address | and age in the code |
| of a name string of field 1; | 0x0c0c0d01//4 bytes, address of the “name″ string in |
| 4 bytes, linear memory address | linear memory, where for example, the address includes a |
| of a return type of field 1; | name of the name field |
| 4 bytes, linear memory address | 0x00030201//4 bytes, start address of the String class in |
| of a name string of field 2; | linear memory, where String itself is also a class, for |
| 4 bytes, linear memory address | example, it is a return type of the name field |
| of a return type of field 2; | 0x0c0d0a03//4 bytes, where an address of an “age” |
| | string in linear memory is a name of an age field |
| | 0x00000001//4 bytes, representing a basic type int, |
| | which is a return type of the age field |
| Method function array structure | Start address: 0x01020430 |
| of the class: | 0x00000002//4 bytes, quantity of methods of the class, |
| 4 bytes, quantity of method | which is 2 here, for example, two functions getSum( ) and |
| functions of the class; | getMultiply( ) |
| 4 bytes, index of function 1 in a | 0x00000001//4 bytes, index of a Person. getSum( ) |
| Wasm function table; | method in the Wasm function table, where the index is |
| 4 bytes, linear memory address | assumed to be 1 here |
| of a name string of function 1; | 0x0d010502//4 bytes, where an address of a “getSum” |
| 4 bytes, linear memory address | string in linear memory is a name of the getSum method |
| of a return type of function 1; | 0x00000001//4 bytes, representing a basic type int, |
| 4 bytes, quantity of parameters | which is a return type of the getSum( ) method |
| of function 1; | 0x00000002//4 bytes, quantity of parameters of the |
| linear memory address of a | function, which is 2 here, for example, two parameters |
| parameter type array of function | 0x03040a0d//4 bytes, linear memory address, for |
| 1; | example, a parameter type array of the getSum( ) method |
| 4 bytes, index of function 2 in a | 0x00000002//4 bytes, index of a Person. getMultiply( ) |
| Wasm function table; | method in the Wasm function table, where the index is |
| 4 bytes, linear memory address | assumed to be 2 here |
| of a name string of function 2; | 0x0d031522//4 bytes, where an address of a |
| 4 bytes, linear memory address | “getMultiply” string in linear memory is a name of the |
| of a return type of function 2; | getMultiply method |
| 4 bytes, quantity of parameters | 0x00000002//4 bytes, representing a basic type int, |
| of function 2; | which is a return type of the getMultiply( ) method |
| linear memory address of a | 0x007a4792//4 bytes, for storing the quantity of |
| parameter type array of function | parameters of the function, which is 2 here, for example, |
| 2; | two parameters |
| 4 bytes, index of function 3 in | 0x04a41242//4 bytes, linear memory address, for |
| the Wasm function table; | example, for storing a parameter type array of the |
| . . . | getMultiply( ) method |
| | 0x0203047d//4 bytes, index of a method in the Wasm |
| | function table, where the index is assumed to be 3 here |
| | . . . |

It is worthwhile to note that the 4 bytes above are used only as an example and do not constitute a limitation.

In addition, as shown in the above table, specific content in the class structure can also be stored in the linear memory, as shown in Table 2 below.

TABLE 2
Content of the class structure

| | |
|---|---|
| Object structure: | Object structure: |
| class; | class; |
| each field array of the object; | each field array of the object; |
| Class structure: | Class structure: |
| name string of the class; | name string of the class; |
| field array of the class; | field array of the class; |
| method function array of the class; | method function array of the class; |
| Field array structure of the class: | Field array structure of the class: |
| name string of a field; | name string of a field; |
| return type of the field; | return type of the field; |
| name string of a field; | name string of a field; |
| return type of the field; | return type of the field; |
| Method function array structure | Method function array structure |
| of the class: | of the class: |
| name string of function 1; | name string of function 1; |
| return type of function 1; | return type of function 1; |
| parameter type array of function 1; | parameter type array of function 1; |
| name string of function 2; | name string of function 2; |
| return type of function 2; | return type of function 2; |
| parameter type array of function 2; | parameter type array of function 2; |
| . . . | . . . |

It can be seen that addresses in some fields in the left column of Table 1 point to some fields in Table 2. This mapping relationship is described in detail later. It is worthwhile to note that the fields in Table 1 are generally located in contiguous memory, so that it is easy to find structures and fields related to the same class in the memory. In addition, in the four blocks in Table 1, at least fields in each block are contiguous, so that each field can be accessed by traversing from the start address by using a pointer in subsequent code snippet 4. The fields in Table 1 store the addresses pointing to the fields in Table 2, that is, the fields in Table 2 in the memory can be found by using the addresses in Table 1. Therefore, the fields in Table 2 do not need to be located in contiguous memory.

Specifically, in the compilation process, a Wasm function module is processed as follows:

```
(module
  (table 1 funcref) // The table includes a virtual method array
  (func $Person_getSum(result i32)(param i32 i32)...)
  (func $Person_getMultiply(result i32)(param i32 i32 )...)
  (elem(i32.const O) $Person_getSum $Person_getMultiply) // The getSum function
```

is placed in the table, with an index of 1, and the getMultiply function is also placed in the table,
with an index of 2

(data 0 ″01010101010101″) // It represents a data segment in initial linear memory,

which includes binary data of the above-mentioned class structure

)

Code snippet 4

Code snippet 3 above means fetching a name string, a return result type, and an input parameter type of a function of a class, to fill in each corresponding field in Table 2, and fill in Table 1 with a linear memory address of each field of the function of this class in Table 2 and a quantity of parameters, meanwhile, creating an index of the function of this class, creating an entry corresponding to index 3 in Table 3, and further filling in a corresponding field in Table 1 with the index. As such, for example, the getSum function is placed in the table, with the index of 1, and the getMultiply function is also placed in the table, with the index of 2.

S120: Generate, based on reflection functionality code in the source code, bytecode of a second function for obtaining a first function type and first function content based on dynamic parameters at runtime.

In the compilation process by the compiler, support for the reflection functionality code in the source code can be added. The compilation process by the compiler is to organize the structure of the Java source code into a suitable format, including performing lexical/syntactic analysis based on an abstract syntax tree in the compilation process, filling symbols based on a symbol table, performing annotation processing, performing semantic analysis and code generation, etc., to finally compile the source code into Wasm bytecode. In this process, when the compiler compiles the reflection functionality code, the compiler can generate the corresponding bytecode of the second function for obtaining the first function type and the first function content based on the dynamic parameters at runtime. For example, for code snippet 3 in the above example, the fifth to seventh lines are the reflection functionality code, and the corresponding bytecode is the bytecode of the second function.

Specifically, to support the reflection functionality code, a reflection library can generally be provided. The reflection library includes some classes that support reflection functionality. In the process of writing the source code, the developer can import the reflection library in a header of a class file based on a syntax rule, for example, import the reflection library by using an import statement. When the compiler compiles the source code, reflection functionality code in a project file can be replaced with related statements in the reflection library, and then the above-mentioned lexical/syntactic analysis, symbol filling, annotation processing, semantic analysis, code generation processes, etc. are performed to generate the bytecode in the Wasm file.

For example, the imported reflection library includes specific implementations of Class.getMethod ( ) and Method.invoke ( ) in the fifth to seventh lines of code above. As such, in the compilation process, the reflection functionality code involved in the source code, that is, the Class.getMethod ( ) and Method.invoke ( ) methods in the fifth to seventh lines, can be replaced with corresponding specific implementations in the reflection library.

The provided reflection library may include specific implementations of Class.getMethod ( ) and Method.invoke ( )

For example, the implementation of Class.getMethod ( ) is as follows:

```
class Class {
    // A main principle is that class information is followed by the method metadata
  array in the Wasm linear memory
  public Method[ ] getDeclaredMethods( ) {
        // Obtain an index from the class to each method function, from the methodIndex
  array after the class structure
        // castType is a type conversion function, and when Wasm is running, each object
  has an address in an int32 format
      RuntimeClass runtimeClass = castType(this);
        // Based on the size of the stored class structure, quickly find the method list array
  following the class structure
        int runtimeClassStructureSize = runtimeClass.classStructureSize;
      // Obtain a start address of a method address array of the class
      Address runtimeClassMethodIndexArrayAddress = Address.ofObject(
          runtimeClass).add(runtimeClassStructureSize);
        // Size of a virtual table of the class (itself + quantity of inherited virtual methods)
      int vtableSize = runtimeClass.vtableSize;
      Method[ ] methods = new Method[vtableSize];
      // Start memory address of the metadata array of the methods in Table 1
      Address methodsPointer = runtimeClassMethodIndexArray Address;
      for (int i=0; i < vtableSize; i++) {
            // methodIndex is an index of a function corresponding to this Java method, in
  a Wasm table
          int methodIndex = methodsPointer.getInt( );
            methodsPointer = methodsPointer.add(4); // Move the pointer 4 bytes in Table 1
          // Read the method name, return type, params, etc. which are omitted here
          // get method info and put method in TMethod[ ]
          Method method = new Method(this, methodIndex);
          methods[i] = method;
      }
      return methods;
  }
}
```

Code snippet 5

Code snippet 5 above is pseudo code for the specific implementation of Class.getMethod in the reflection library. As mentioned above, the reflection library in which the code is located can be imported. As such, imported code of a related reflection function can replace a call in Java code written by a user in the compilation process. In code snippet 5 above, function names concatenated in the eleventh line are used to traverse a method object array of the class obtained in code snippet 5 until a first function with the same name string is matched, so that an index of the first function in Table 1 can be obtained.

For example, the implementation of Method.invoke ( ) is as follows:

```
Class Method{
  int funcIndex; // Index of a Wasm function of a wrapped Java method, where for
example, an index of the getSum function is 1
  Object invoke(Object obj, Object... args){
    switch(args.length){
      case 0: return call indirect(funcIndex);
      case 1: return call indirect(funcIndex, args[0]);
      case 2: return call indirect(funcIndex, args[0], args[1]);
      ...
      case n: return call_indirect(funcIndex, args[0], ... args[n−1]);
      ...
      }
    }
  }
```

Code snippet 6

Code snippet 6 is pseudo code for the specific implementation of Method.invoke in the reflection library. In code snippet 3 above, the index of the first function matched by the name string in Table 1 is obtained by using the Class.getMethod ( ) function in the fifth line, and can be specifically obtained by using p.getClass ( ) getMethod ( ) above. A specific implementation of this function is the same as the implementation in code snippet 5 above. Then the seventh line in code snippet 3 can be executed, that is, the corresponding first function is called. Specifically, in code snippet 6, a quantity of parameters in a corresponding case is verified again based on a quantity of input parameters. If the quantity is consistent with a corresponding quantity in Table 1, an indirect call is made. For example, the index of getSum in Table 1 is 1. By using the fifth line in code snippet 3, the getSum string can be matched in Table 1 to find that the index is 1. Then by using a switch statement in code snippet 6, verification can be performed again based on the two parameters input by the getSum function that initiates the call. It can be verified that funcIndex in case 2 is 1 and that the quantity of parameters is also 2. As such, an indirect call can be initiated to the function whose funcIndex is 1, that is, the start address of the getSum ( ) function in subsequent Table 4 is found by using the index 1 in subsequent Table 3, and then the virtual machine parses code corresponding to the start address in Table 4 and executes the code.

Before executing the compiled Wasm bytecode, the virtual machine can load the Wasm bytecode. First, an entry function can be used, for example, a function that matches the function sum ( ) 1 and an input parameter. For example, the code is as follows:

```
  @ContractInterface // It indicates that the following is an exposed interface
  public int sum(int a) {
  int b = 1024;
    int sum = (Integer) getProperty(new Person( ), ″Sum″, a, b);
      return sum;
  }
}
```

Code snippet 7

As such, sum ( ) a is converted into an implementation of getProperty ( ) An input parameter of sum ( ) can be different from an input parameter of getProperty ( ) For example, here, the input parameter of sum ( ) is a parameter a, while getProperty ( ) has two input parameters a and b in addition to a called object and a called method name. According to the above code, one of the two input parameters of getProperty ( ) a, is the input parameter a of the sum ( ) function, and the other parameter b of the two input parameters of getProperty ( ) can be set to a specified value. The value can be a constant or a global variable, the latter of which, for example, is read from other values. With reference to the implementation defined in the tenth to fourteenth lines in code snippet 2, sum ( ) can be converted into processing of the getProperty ( ) function.

Before the Wasm file is executed, the virtual machine first loads the Wasm file and performs the following process shown in FIG. 2.

S210: Create a linear memory area.

Physical memory is generally managed by the operating system. For example, it is responsible for establishing a mapping relationship between logical addresses and physical addresses. The Wasm virtual machine can maintain a linear memory area. The linear memory area is part of the memory managed by the operating system and is managed and controlled by Wasm. Specifically, Wasm can perform another layer of abstraction on a basis of the memory managed by the operating system, to obtain an address, for example, a linear memory area starting from 0, and can control access to the linear memory based on an offset. As mentioned above, the Wasm virtual machine can further manage part of non-linear memory, which is referred to as normal memory here.

After loading the Wasm file and before executing the bytecode, the Wasm virtual machine can create the linear memory area.

S220: Initialize at least part of memory in the linear memory area by using the metadata in the Wasm file.

As mentioned above, the Wasm file includes metadata and bytecode of classes and functions. After the Wasm virtual machine loads the Wasm file, the linear memory area can be created, and then the virtual machine can initialize at least part of the linear memory by using the metadata of the first class and the first function included in the Wasm file. As mentioned above, the address of the linear memory can start from 0, and this address can be referred to as a base address of the linear memory in the operating system; and other addresses in the linear memory are equivalent to offsets relative to this base address. As such, for the address a in the linear memory, the corresponding memory address in the operating system is the base address of the linear memory in the operating system+an offset a in the linear memory. This abstraction of the operating system memory by the Wasm virtual machine helps the Wasm virtual machine better manage and use the memory.

As such, before the Wasm bytecode is executed, the linear memory is non-empty; and before the Wasm bytecode instructions are executed, constants, the metadata of the classes, and functions, etc. in the code are preloaded into the linear memory, and the addresses in the linear memory are fixed, facilitating deterministic calls during subsequent execution of the Wasm bytecode.

In addition, as mentioned above, after the Wasm virtual machine loads the Wasm file, a normal memory area can also be created, and then the virtual machine can initialize at least part of the normal memory by using the bytecode of the first function and the bytecode of the second function included in the Wasm file. Functions called by objects instantiated from a class during execution are stored in a storage area corresponding to the class. The storage area corresponding to this class is generally located in the normal memory created by the virtual machine. In other words, the functions in the class are located in the normal memory area. Objects created based on the class are instances of the class. When functions in the class are executed, the corresponding functions, including the first function and the second function, need to be loaded from the normal memory and executed.

After initializing at least part of the normal memory by using the first function, the virtual machine can generate two tables, which are a function table in Table 3 and function code in Table 4 respectively.

The function table can be shown in the table below.

TABLE 3
Function table in the normal memory

| | |
|---|---|
| Index of function 1 in | Function 1: |
| the table | start address of function 1 in the normal memory; |
| Index of function 2 in | Function 2: |
| the table | start address of function 2 in the normal memory; |
| Index of function 3 in | Function 3: |
| the table | start address of function 3 in the normal memory; |
| . . . | . . . |

The function code can be shown in the table below.

TABLE 4
Function in the normal memory

| | |
|---|---|
| Start address of code of function 1 in | Code of function 1: |
| the memory | . . . |
| Start address of code of function 2 in | Code of function 2: |
| the memory | . . . |
| Start address of code of function 3 in | Code of function 3: |
| the memory | . . . |
| . . . | . . . |

For example, the first function includes function 1, function 2, function 3 . . . . As shown above, in Table 4, a code data block of function 1 is stored in the normal memory and has a start address in the normal memory managed by the virtual machine. Similarly, a code data block of function 2 has a start address in the normal memory, and a code data block of function 3 has a start address in the normal memory. The function table in Table 3 can store the start address of the code of each function in the normal memory in a short and regular format, for example, one 32-bit address per row in Table 3.

It can be seen that the first function in the first class mentioned above may include a plurality of functions. To facilitate unified management of the functions in the first class in the memory, the start address of each function in Table 4 in the normal memory can be inserted into a corresponding position in Table 3, so that the function table can be uniformly mapped to different function code.

In a process of generating Table 3, the virtual machine can obtain the start address of Table 3 in the normal memory. Therefore, based on the start address and the index of Table 3, the start address of the corresponding function in Table 4 can be obtained.

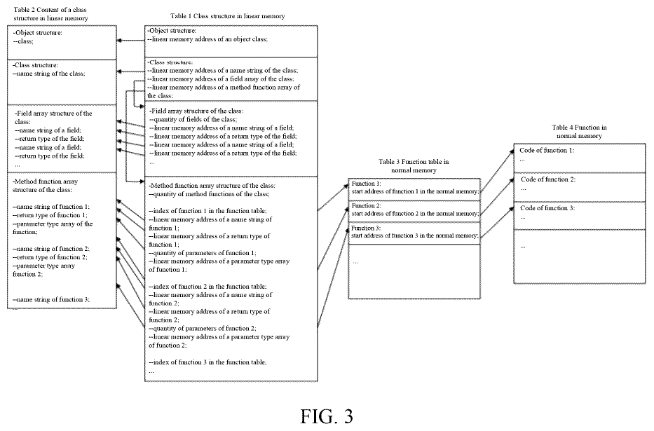

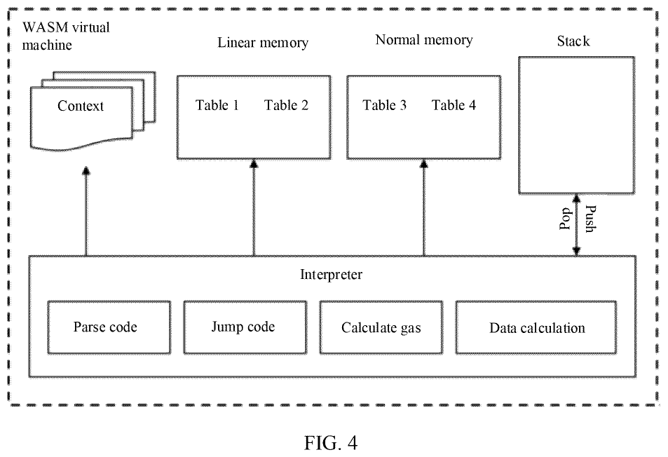

Table 1, Table 2, Table 3, and Table 4 above can be combined to form an entire mapping table. The mapping table can be shown in FIG. 3. Table 1 and Table 2 can be stored in the linear memory, and their addresses are determined by the compiler during compilation and are fixed. Table 3 and Table 4 are stored in the normal memory. The value of each item in the function table in Table 3 can point to the start address of the corresponding function code in Table 3. It can be as shown in FIG. 4 from a perspective of the virtual machine.

S230: Parse and execute the bytecode in the Wasm file, and when executing the bytecode of the second function, determine the called first function in the linear memory area based on dynamic parameters of the called function and the metadata, and execute the first function.

When the bytecode in the Wasm file is loaded into the virtual machine, the functions in the class are also loaded into the normal memory in the virtual machine, as in the initialization process of a normal function mentioned above. Running of the Wasm bytecode involves numerical calculation, memory read and write operations, function calls, etc. Memory space operated on by the Wasm bytecode is the linear memory created before running, and the normal memory cannot be directly operated on. The virtual machine can operate on the normal memory to ensure that the Wasm bytecode will not directly modify the function bytecode in the normal memory.

The virtual machine parses and executes the Wasm bytecode, following the logic in the Wasm bytecode. When the reflection functionality code in the bytecode of the second function is executed, the actually called function can be dynamically determined based on the dynamic parameters of the called function. Specifically, when the bytecode of the second function is executed, the following operations can be performed.

When the eleventh line of code in code snippet 2 above is executed, the function names are concatenated.

When the twelfth line of code (actually including content of code snippet 4 after replacement) is executed, the function names concatenated in the eleventh line are used to traverse the virtual table until the first function with the same name string is matched, so that the index of the first function in Table 1 can be obtained.

When the thirteenth line of code in code snippet 2 (actually further including content of code snippet 5 after replacement), is executed, a call is initiated to the corresponding first function. Specifically, in code snippet 5, a quantity of parameters in a corresponding case is verified again based on a quantity of input parameters. If the quantity is consistent with a corresponding quantity in Table 1, an indirect call is made. For example, the index of getSum in Table 1 is 1. By using the twelfth line in code snippet 2 (and the content of code snippet 4 after replacement), the getSum string can be matched in Table 1 to find that the index is 1. Then by using a switch statement in code snippet 5, verification can be performed again based on the two parameters input by the getSum function that initiates the call. It can be verified that funcIndex in case 2 is 1 and that the quantity of parameters is also 2. As such, an indirect call can be initiated to the function whose funcIndex is 1, that is, the start address of the getSum ( ) function in subsequent Table 4 is found by using the index 1 in subsequent Table 3, and then the code corresponding to the start address in Table 4 is parsed and executed.

Similarly, for example, the index of getMultiply in Table 1 is 2. By using the twelfth line in code snippet 2 (and the content of code snippet 4 after replacement), the getMultiply string can be matched in Table 1 to find that the index is 2. Then by using a switch statement in code snippet 5, verification can be performed again based on the two parameters input by the getMultiply function that initiates the call. It can be verified that funcIndex in case 2 is 2 and that the quantity of parameters is also 2. As such, an indirect call can be initiated to the function whose funcIndex is 2, that is, the start address of the getMultiply ( ) function in subsequent Table 4 is found by using the index 2 in subsequent Table 3, and then the code corresponding to the start address in Table 4 is parsed and executed.

In the above example, based on the function name string of the called function and the metadata, the called first function in the linear memory area can be determined and executed. In addition to the concatenated strings mentioned above, the string can also be a string input by the user or a string constructed from integers or binary data.

According to the above-mentioned embodiments, reflection functionality can be implemented in the Wasm file, so that when the Wasm program is running, the Wasm program is capable of accessing, detecting, and changing its own status or behavior. Especially, when there are a plurality of functions, it is convenient for the developer to flexibly and easily call different functions in the code by using the reflection functionality during code development. For example, the developer can develop Java source code including reflection programming functionality. Reflection programming is, for example, obtaining a class of an object, and the obtained class includes fields, methods, etc. Specifically, a blockchain platform vendor can provide auxiliary functions. For example, the auxiliary functions are located in a reflection library, The auxiliary functions may include some APIs for obtaining metadata of classes and functions. This function library can be provided for the developer, and then the developer can include this function library into the source code in the process of code development using a high-level language, and call such APIs in the function library in the source code, thereby obtaining the metadata of the classes and functions by using these auxiliary functions in the source code. In addition, an original function library can also be used. For example, Java itself includes a function library that provides reflection programming functionality. As such, in the process of developing the source code by using the Java language, the developer can introduce the reflection programming functionality provided by the function library.

As mentioned above, a corresponding source file can be generated based on the code edited in the Java language after the developer completes writing. The source file generally has an extension .java. The .java file of the code can be compiled by the compiler to generate bytecode in the Wasm format. The bytecode in the Wasm format can be encapsulated into a wasc file. In addition, it is also possible to develop Java bytecode in other blockchain systems that support reflection functionality, such as a file with a .class extension, and the Java bytecode includes reflection functionality code. The Java bytecode is a program equivalent to the Java source code. Therefore, the compiler in the embodiments of this application can also be used to recompile the Java bytecode including reflection functionality to generate Wasm bytecode. In this case, the generated Wasm bytecode also has reflection functionality, and the reflection functionality can be implemented when the virtual machine executes the Wasm bytecode.

In addition, as mentioned above, high-level languages with reflection programming functionality further include C#, Python, the Go language, etc. in addition to Java. Code developed in some programming languages such as C++ that do not support the reflection mechanism can also implement reflection functionality by using the reflection library, compiler, and virtual machine provided in this application.

The following describes embodiments of a method for compiling code including reflection functionality in this application. The code including reflection functionality includes source code or intermediate bytecode. The source code is, for example, Java source code, such as source code with a .java extension. The intermediate bytecode is, for example, Java bytecode, such as Java bytecode with a .class extension. A compiler can integrate a Java compilation toolchain. The Java source code can be first compiled into Java bytecode, and the process in the following method embodiment can be performed.

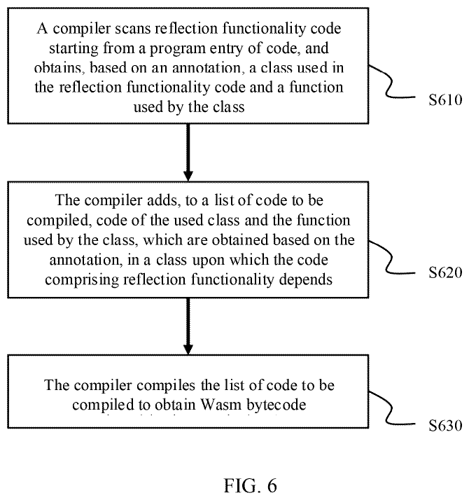

As shown in FIG. 6, the method includes S610 to S630.

S610: The compiler scans reflection functionality code starting from a program entry of the code, and obtains, based on an annotation, a class used in the reflection functionality code and a function used by the class.

When developing source code, a developer can use a reflection mechanism, that is, the reflection functionality code can be included. As mentioned above, the reflection functionality code represents the dynamic nature of program execution, allowing the program to dynamically detect its own status or behavior at runtime. More specifically, a function can be dynamically called according to an input instruction or command, and this function is uncertain before being called.

Although the function is uncertain, the developer can expect that the dynamically called function is limited to a small range, for example, code snippet 2 above and code snippet 8 below. Still as mentioned above, in code snippet 2, Person defines three functions: getSum, getMultiply, and hello. Input parameters of the first two functions getSum and getMultiply are the same, both being two integer variables a and b. An input parameter of the last function hello is different from those of the first two functions, and is a string variable name.

| | |
|---|---|
| 1 | import Person |
| 2 | class Main { |
| 3 | @LinkClass(target = Person.class, methods = { ″getSum″, ″getMultiply″ }) |
| 4 | public static void main(String[ ] args) { |
| 5 | String methodName = args[0]; |
| 6 | Method method = Person.class.getMethod(methodName, int.class, |
| 7 | int.class); |
| 8 | System.out.println(method.invoke(123,234)); |
| 9 | } |
| | } |

Code snippet 8: Main.java

Person in code snippet 2 is first imported in Main.java in code snippet 8, and a class Main is defined. The class Main defines a function Main. In the function Main, a method name and two parameters of an integer type are obtained by using the method in the sixth and seventh lines. A function corresponding to the method name is called in the eighth line, and parameters 123 and 234 are input. The sixth and seventh lines include a reflection functionality function, that is, person.class.getMethod (methodName, int.class, int.class) is used to obtain a function with the same function name and the same input and output parameters (or return type) in a class to which an object Person belongs (including other subclasses inherited from an Object class) (the function name and input and output parameters are also referred to as a function signature). In the eighth line of code, the fetched function is used to complete calculation and return a calculation result.

In sixth and seventh lines in code snippet 8 above, from a perspective of a function input parameter quantity being 2 and an input parameter type being int, only the getSum or getMultiply function in code snippet 1 can be called, and the hello function will not be called. In this case, for the compilation process, if the Person class including the hello function is packaged together, useless functions will take up a large file size.

Therefore, the developer can add an annotation to the third line in code snippet 8, such as code starting with “@LinkClass . . . ”. The Java annotation, also known as a Java comment, is a special code comment in the Java programming language. Java annotations can be added to classes, fields, methods, constructors, etc. in Java code to describe some required information, and a Java reflection mechanism can be used to obtain annotation objects of these classes, fields, or methods, so that the annotation information can be obtained at runtime.

Here, the developer can use the annotation in the third line to annotate the subsequent class and functions used by the class. For example, in the third line, the annotation specifies the class Person.class, that is, the Person class, and the functions used in the Person class are getSum and getMultiply. The annotation includes the Person class, specifying the Person class imported in the first line in code snippet 8. The functions used in the Person class in the annotation are getSum and getMultiply, which means that only code of the two functions getSum and getMultiply in the Person class needs to be compiled during compilation. The Person class in the annotation does not include hello, which means that code of the hello function in the Person class does not need to be compiled during compilation.

The compilation process by the compiler includes organizing the structure of the Java source code (or Java bytecode) into a suitable format, including performing lexical/syntactic analysis based on an abstract syntax tree in the compilation process, filling symbols based on a symbol table, performing annotation processing, performing semantic analysis and code generation, etc., to finally encode the source code into Wasm bytecode. In this process, the compiler starts scanning from the program entry of the code to be compiled, that is, starting from the function Main, the compiler scans classes used in the function Main, field types in the classes, method functions used, and function call information in the functions, and constructs a list of classes used by the program, along with the method functions used.

The compiler scans the reflection functionality code starting from the program entry of the code, and can start scanning from Main. After the reflection functionality code is scanned, for an annotation included before the reflection functionality code, content in the annotation can be obtained. Java annotations are a special type without function logic, similar to special comments that can be read in Java code. A difference lies in that content of a comment cannot be obtained after Java code is compiled into bytecode, but a Java annotation, that is, a java annotation, can be obtained at runtime, so that it is possible to identify which annotations are in a header of a method and what properties the annotations have. The compiler can read a LinkClass annotation in the method Main and read a property value of this annotation. Generally, an annotation can be represented by code starting with @LinkClass or @LinkClasses. Code starting with @LinkClass can represent an annotation for a single class, and code starting with @LinkClasses can represent an annotation for a plurality of LinkClasses. Code snippet 8 above shows the form starting with @LinkClass. The form starting with @LinkClasses includes an annotation for a plurality of LinkClasses.

By using the subsequent property value (target=Person.class, methods={“getSum”, “getMultiply”}), the form starting with @LinkClass can specify the class and function used in the subsequent reflection functionality code, as shown in code snippet 8. The class used, for example, is represented by target=referenced class.class. The functions used in the class, for example, are represented by methods={“referenced method 1”, “referenced method 2”, . . . }. In code snippet 8, target=Person.class specifies that the class used in the subsequent reflection functionality code is the Person class, and methods={“getSum”, “getMultiply”} indicates that the functions to be used in the Person class include the two functions getSum and getMultiply, but not other functions in the Person class. As mentioned above, these can be read by the compiler.

It is worthwhile to note that code snippet 2 above is a custom Person class, which includes three member functions described as examples. Actually, the class can be other classes, and can be explicitly expressed by import at the top of code snippet 8, or implicitly included, that is, not included by import.

The other classes can be directly or indirectly depended classes, such as a standard class String.class. There are many methods in the class String.class, possibly more than one hundred. The annotation can specify the methods used. It can be considered that methods not specified in the annotation will not be used.

S620: The compiler adds, to a list of code to be compiled, code of the used class and the function used by the class, which are obtained based on the annotation, in a class upon which the code including reflection functionality depends.

In the compilation process, as described in S610, the compiler can start scanning from the program entry. A class name can be obtained based on an annotation field “target= . . . ”, and a function list can be obtained based on an annotation field “methods= . . . ”. If the function list is not empty, functions in the function list can be added to the list of code to be compiled. The function here includes code of a function prototype in a depended library.

S630: The compiler compiles the list of code to be compiled to obtain Wasm bytecode.

For Java, an underlying implementation of the compiler, for example, can be based on a TeaVM. The TeaVM is a translator, capable of translating JVM bytecode into Wasm bytecode. In the translation process, the TeaVM does not necessarily require Java source code, but can be implemented with .class files (that is, Java bytecode). For a specific process of translation by the TeaVM, there are a mature engineering implementation and public documentation. Details are not described here.

According to the above-mentioned embodiments, for directly or indirectly depended classes, only functions specified by the annotation will be compiled together. In these directly or indirectly depended classes, many functions that will not be subsequently called will not be compiled by the compiler. Therefore, in the compilation process, the compiler can have a capability of “compilation on demand”. This can not only reduce complexity and workload of the compiler, but also greatly reduce a size of a compilation result. Moreover, due to the small size of the compilation result, code loaded into the linear memory of the Wasm virtual machine will also be greatly reduced, and overall performance of the Wasm virtual machine can be improved.

In addition, in this method, the Wasm virtual machine does not need to integrate a dynamic loading capability, and changes to Wasm are relatively small. Certainly, a person skilled in the art knows that the embodiments do not exclude the Wasm virtual machine from having the dynamic loading capability.

Furthermore, the above-mentioned implementation process of S110 and S120 and S210 to S230 can be applied not only to high-level languages with reflection programming functionality, such as Java, C#, Python, and Go, but also to code developed by using programming languages that originally do not support the reflection mechanism, that is, the reflection functionality can also be implemented by using the reflection library, compiler, and virtual machine provided in this application, such as the C++ language. Furthermore, the above-mentioned embodiments of S610 to S630 in this application can also be applied to high-level languages that originally do not support the reflection function, such as the C++ language, and that implement the reflection functionality by using the reflection library, compiler, and virtual machine provided in this application.

The following describes embodiments of a compiler according to this application. The compiler includes: a scanning unit, configured to scan reflection functionality code starting from a program entry of code, and obtain, based on an annotation, a class used in the reflection functionality code and a function used by the class; an addition unit, configured to add, to a list of code to be compiled, code of the used class and the function used by the class, which are obtained based on the annotation, in a class upon which the code including reflection functionality depends; and a compilation unit, configured to compile the list of code to be compiled to obtain Wasm bytecode.

The following describes embodiments of a computer device according to this application. The computer device includes a processor and a memory. The memory stores a program. When the processor executes the program, the following operations are performed: scanning reflection functionality code starting from a program entry of code, and obtaining, based on an annotation, a class used in the reflection functionality code and a function used by the class; adding, to a list of code to be compiled, code of the used class and the function used by the class, which are obtained based on the annotation, in a class upon which the code including reflection functionality depends; and compiling the list of code to be compiled to obtain Wasm bytecode.

The following describes embodiments of a storage medium according to this application. The storage medium is configured to store a program. When the program is executed, the following operations are performed: scanning reflection functionality code starting from a program entry of code, and obtaining, based on an annotation, a class used in the reflection functionality code and a function used by the class; adding, to a list of code to be compiled, code of the used class and the function used by the class, which are obtained based on the annotation, in a class upon which the code including reflection functionality depends; and compiling the list of code to be compiled to obtain Wasm bytecode.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. A designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Before compilation, source code needs to be written in a particular programming language, which is referred to as a hardware description language (HDL). The HDL is not limited to only one type. Instead, there are many types of HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also be aware that a hardware circuit that implements a logical method procedure can be readily obtained once the method procedure is logically programmed by using the several hardware description languages and is programmed into an integrated circuit.

A controller can be implemented in any appropriate way. For example, the controller can take a form of a microprocessor or a processor and a computer-readable medium storing computer-readable program code (such as software or firmware) executable by the microprocessor or the processor, a logic gate, a switch, an application-specific integrated circuit (ASIC), a programmable logic controller, and an embedded microcontroller. Examples of the controller include but are not limited to the following microcontrollers: ARC 625D, Atmel AT91SAM, Microchip PIC18F26K20, and Silicone Labs C8051F320. A memory controller can also be implemented as part of control logic of the memory. A person skilled in the art also knows that, in addition to implementing the controller in a form of pure computer-readable program code, a method step can be logically programmed, so that the controller implements the same function in a form of a logic gate, a switch, an application-specific integrated circuit, a programmable logic controller, an embedded microcontroller, etc. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a server system. Certainly, this application does not exclude that with development of computer technologies in the future, a computer that implements functions of the above-mentioned embodiments may be, for example, a personal computer, a laptop computer, a vehicle-mounted human-computer interaction device, a cellular phone, a camera phone, a smartphone, a personal digital assistant, a media player, a navigation device, an email device, a game console, a tablet computer, a wearable device, or a combination of any of these devices.

Although one or more embodiments of this specification provide the method operation steps described in the embodiments or flowcharts, more or fewer operation steps can be included based on conventional or non-creative means. A sequence of steps listed in the embodiments is merely one of various step execution sequences and does not represent a sole execution sequence. In practice, when being executed by an apparatus or an end-user device product, the steps can be executed sequentially or in parallel (for example, by parallel processors or in a multi-thread processing environment, or even in a distributed data processing environment) based on the method shown in the embodiments or the accompanying drawings. The terms “comprise”, “include”, or any other variants thereof are intended to cover a non-exclusive inclusion, so that a process, a method, a product, or a device that includes a list of elements not only includes those elements but also includes other elements that are not expressly listed, or further includes elements inherent to the process, method, product, or device. Without more constraints, the existence of additional identical or equivalent elements in the process, method, product, or device that includes the elements is not excluded. For example, if words such as first and second are used to represent names, they do not represent any particular sequence.

For ease of description, the above-mentioned apparatus is described by dividing functions into various modules. Certainly, during implementation of one or more embodiments of this specification, the functions of the modules can be implemented in same one or more pieces of software and/or hardware, or modules implementing a same function can be implemented by using a combination of a plurality of sub-modules or sub-units, etc. The above-mentioned apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

This application is described with reference to the flowcharts and/or block diagrams of the method, the apparatus (system), and the computer program product based on the embodiments of this application. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a function specified in one or more procedures in the flowcharts and/or one or more blocks in the block diagrams.

These computer program instructions can also be stored in a computer-readable memory that can instruct a computer or another programmable data processing device to work in a specific way, so that an instruction stored in the computer-readable memory generates an artifact including an instruction apparatus, and the instruction apparatus implements a function specified in one or more procedures in the flowcharts and/or one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a function specified in one or more procedures in the flowcharts and/or one or more blocks in the block diagrams.

In a typical configuration, a computing device includes one or more processors (CPUs), one or more input/output interfaces, one or more network interfaces, and one or more memories. The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should understand that one or more embodiments of this specification may be provided as a method, a system, or a computer program product. Therefore, one or more embodiments of this specification may take a form of a hardware-only embodiment, a software-only embodiment, or an embodiment with a combination of software and hardware. Moreover, one or more embodiments of this specification may take a form of a computer program product implemented on one or more computer-usable storage media (including but not limited to a disk memory, a CD-ROM, an optical memory, and the like) that include computer-usable program code.

One or more embodiments of this specification can be described in a general context of a computer-executable instruction executed by a computer, for example, a program module. Generally, the program module includes a routine, a program, an object, a component, a data structure, etc. executing a specific task or implementing a specific abstract data type. One or more embodiments of this specification can also be practiced in a distributed computing environment. In the distributed computing environment, tasks are executed by remote processing devices that are connected through a communication network. In the distributed computing environment, the program module can be located in both local and remote computer storage media including storage devices.

The embodiments of this specification are all described in a progressive way. Mutual reference can be made for the same or similar parts between the embodiments. Each embodiment focuses on differences from other embodiments. Particularly, a system embodiment is similar to a method embodiment, and therefore is described briefly. For related parts, reference can be made to related descriptions in the method embodiment. In the description of this specification, the terms “an embodiment”, “some embodiments”, “an example”, “a specific example”, or “some examples” mean that a specific feature, structure, material, or characteristic described with reference to the embodiment or example is included in at least one embodiment or example of this specification. In this specification, illustrative expressions of these terms do not necessarily refer to the same embodiment or example. Moreover, the specific feature, structure, material, or characteristic described may be combined in any suitable manner in any one or more embodiments or examples. In addition, without mutual conflict, those skilled in the art may incorporate and combine different embodiments or examples and features of the different embodiments or examples described in this specification.

The above-mentioned descriptions are merely embodiments of one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

What is claimed is:

1. A computer-implemented method for compiling code comprising reflection functionality, comprising:
scanning, by a compiler, reflection functionality code starting from a program entry of the code;
obtaining, based on an annotation and as a used class, a class used in the reflection functionality code and a function used by the class;
adding, by the compiler to a list of code to be compiled, code of the used class and the function used by the class, which are obtained based on the annotation, in a class upon which the code comprising reflection functionality depends; and
compiling, by the compiler, the list of code to be compiled to obtain WebAssembly bytecode.

2. The computer-implemented method of claim 1, wherein the code comprising reflection functionality comprises source code or intermediate bytecode.

3. The computer-implemented method of claim 2, wherein the compiler integrates a compilation toolchain for compiling the source code into the intermediate bytecode.

4. The computer-implemented method of claim 1, wherein the annotation is represented by code starting with @LinkClass or @LinkClasses.

5. The computer-implemented method of claim 4, wherein by using subsequent property values (target=referenced class.class, methods={“referenced method 1”, “referenced method 2”, . . . }), the code starting with @LinkClass specifies the class used in subsequent reflection functionality code and the function used by the class.

6. The computer-implemented method of claim 1, wherein the class upon which the reflection functionality code depends comprises a depended class comprised in an explicit or implicit manner.

7. The computer-implemented method of claim 1, wherein the class upon which the reflection functionality code depends comprises a directly or indirectly depended class.

8. The computer-implemented method of claim 1, wherein the code of the function used by the class comprises code of a function prototype.

9. The computer-implemented method of claim 1, wherein the computer-implemented method is applied to a blockchain.

10. A non-transitory, computer-readable medium storing one or more instructions executable by a computer system to perform one or more operations for compiling code comprising reflection functionality, comprising:
scanning, by a compiler, reflection functionality code starting from a program entry of the code;
obtaining, based on an annotation and as a used class, a class used in the reflection functionality code and a function used by the class;
adding, by the compiler to a list of code to be compiled, code of the used class and the function used by the class, which are obtained based on the annotation, in a class upon which the code comprising reflection functionality depends; and
compiling, by the compiler, the list of code to be compiled to obtain WebAssembly bytecode.

11. The non-transitory, computer-readable medium of claim 10, wherein the code comprising reflection functionality comprises source code or intermediate bytecode.

12. The non-transitory, computer-readable medium of claim 11, wherein the compiler integrates a compilation toolchain for compiling the source code into the intermediate bytecode.

13. The non-transitory, computer-readable medium of claim 12, wherein the annotation is represented by code starting with @LinkClass or @LinkClasses.

14. The non-transitory, computer-readable medium of claim 13, wherein by using subsequent property values (target=referenced class.class, methods={“referenced method 1”, “referenced method 2”, . . . }), the code starting with @LinkClass specifies the class used in subsequent reflection functionality code and the function used by the class.

15. The non-transitory, computer-readable medium of claim 10, wherein the class upon which the reflection functionality code depends comprises a depended class comprised in an explicit or implicit manner.

16. The non-transitory, computer-readable medium of claim 10, wherein the class upon which the reflection functionality code depends comprises a directly or indirectly depended class.

17. The non-transitory, computer-readable medium of claim 10, wherein the code of the function used by the class comprises code of a function prototype.

18. The non-transitory, computer-readable medium of claim 10, wherein the one or more operations are applied to a blockchain.

19. A computer-implemented system for compiling code comprising reflection functionality, comprising:
one or more computers; and
one or more computer memory devices interoperably coupled with the one or more computers and having tangible, non-transitory, machine-readable media storing one or more instructions that, when executed by the one or more computers, perform one or more operations, comprising:
scanning, by a compiler, reflection functionality code starting from a program entry of the code;
obtaining, based on an annotation and as a used class, a class used in the reflection functionality code and a function used by the class;
adding, by the compiler to a list of code to be compiled, code of the used class and the function used by the class, which are obtained based on the annotation, in a class upon which the code comprising reflection functionality depends; and
compiling, by the compiler, the list of code to be compiled to obtain WebAssembly bytecode.

20. The computer-implemented system of claim 19, wherein the code comprising reflection functionality comprises source code or intermediate bytecode.
